(19) United States
(12) Patent Application Publication
(10) Pub. No.: US 2025/0147309 A1
(43) Pub. Date: May 8, 2025

(54) DISPLAY DEVICE AND LIGHT GUIDE MANUFACTURING METHOD

(71) Applicant: Panasonic Automotive Systems Co., Ltd., Kanagawa (JP)

(72) Inventor: Keiji SUGIYAMA, Kyoto (JP)

(73) Assignee: Panasonic Automotive Systems Co., Ltd., Kanagawa (JP)

(21) Appl. No.: 19/018,919

(22) Filed: Jan. 13, 2025

Related U.S. Application Data
(63) Continuation of application No. PCT/JP2023/045346, filed on Dec. 18, 2023.

(30) Foreign Application Priority Data
Dec. 28, 2022 (JP) 2022-211144

(51) Int. Cl. G02B 27/01

(52) U.S. Cl. CPC G02B 27/0103; G02B 2027/013

(57) ABSTRACT

A display device includes: a light guide that is curved; and an image light emitter that outputs image light to the light guide. Furthermore, the light guide includes: a first light guide layer; a second light guide layer; and an optical element that is disposed between the first light guide layer and the second light guide layer and diffracting and emitting light (image light) propagating in the first light guide layer and the second light guide layer. Moreover, the first light guide layer has a thickness less than a thickness of the second light guide layer.

### CROSS REFERENCE TO RELATED APPLICATIONS

This is a continuation application of PCT International Patent Application No. PCT/JP2023/045346 filed on Dec. 18, 2023, designating the United States of America, which is based on and claims priority of Japanese Patent Application No. 2022-211144 filed on Dec. 28, 2022.

### FIELD

The present disclosure relates to a display device and a light guide manufacturing method.

### BACKGROUND

Patent Literature (PTL) 1 discloses an optical waveguide that includes a plurality of partial optical waveguides planarly formed and including optical filters. The optical waveguide includes a substrate, a hologram layer disposed on the substrate, and a cover layer disposed on the hologram layer

### CITATION LIST

### Patent Literature

PTL 1: Japanese Unexamined Patent Application Publication (Translation of PCT Application) No. 2021-528680

### SUMMARY

However, the above-described optical waveguide in Patent Literature 1 can be improved upon.

In view of this, the present disclosure can improve upon the related art.

A display device according to an aspect of the present disclosure includes: a light guide that is curved; and an image light emitter that outputs image light to the light guide, wherein the light guide includes: a first light guide layer; a second light guide layer; and an optical element that is disposed between the first light guide layer and the second light guide layer, the optical element diffracting and emitting light propagating in the first light guide layer and the second light guide layer, and the first light guide layer has a thickness less than a thickness of the second light guide layer.

A method for manufacturing a light guide according to an aspect of the present disclosure includes: bonding an optical element to a first light guide layer, the optical element diffracting and emitting light; bonding the first light guide layer to which the optical layer has been bonded, to a second light guide layer so that the optical element is disposed between the first light guide layer and the second light guide layer; wherein the second light guide layer is curved, and the first light guide layer has a thickness less than a thickness of the second light guide layer.

It should be noted that some specific aspects among the above aspects may be realized using a system, a method, an integrated circuit, a computer program, or a computer-readable recording medium such as a CD-ROM, or may be realized using any combination of a system, a method, an integrated circuit, a computer program, and a recording medium.

The display device, and so on, according to the present disclosure is capable of improving upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1A is a schematic diagram illustrating an example of a vehicle in which a display device according to an embodiment is disposed.

FIG. 1B is a schematic diagram illustrating the display device according to the embodiment and the vehicle viewed in the rightward direction.

FIG. 2 is a perspective view of the display device according to the embodiment.

FIG. 3 is a diagram illustrating the display device.

FIG. 4 is a cross-sectional view of a light guide.

FIG. 5 is a flowchart illustrating a light guide manufacturing method.

FIG. 6 is a perspective view of a display device according to a variation.

### DESCRIPTION OF EMBODIMENTS

Hereinafter, embodiments will be described in detail with reference to the Drawings.

It should be noted that each of the embodiments described below shows a general or specific example. The numerical values, shapes, materials, elements, the arrangement and connection of the elements, steps, the processing order of the steps, etc., indicated in the following embodiments are mere examples, and thus are not intended to limit the present disclosure. Furthermore, among the elements described in the following embodiments, elements not described in any one of the independent claims are described as optional elements.

Furthermore, the respective figures are schematic diagrams and are not necessarily precise illustrations. Moreover, in the figures, elements which are the same are given the same reference signs.

In the following embodiment, expressions such as “rectangular (in shape)” as well as “almost entirely” will be used. For example, “rectangular” or “entire” not only means being perfectly rectangular or the entirety, but also means being substantially rectangular or entirely, that is, they mean a state including an error of, for example, approximately several percent. Moreover, “rectangular” or “almost entirely” means being rectangular or entire to the extent that the effects of the present disclosure can be achieved. The same applies to other expressions using “shape” or “approximately”.

### Embodiment

### Configuration: Display Device 1

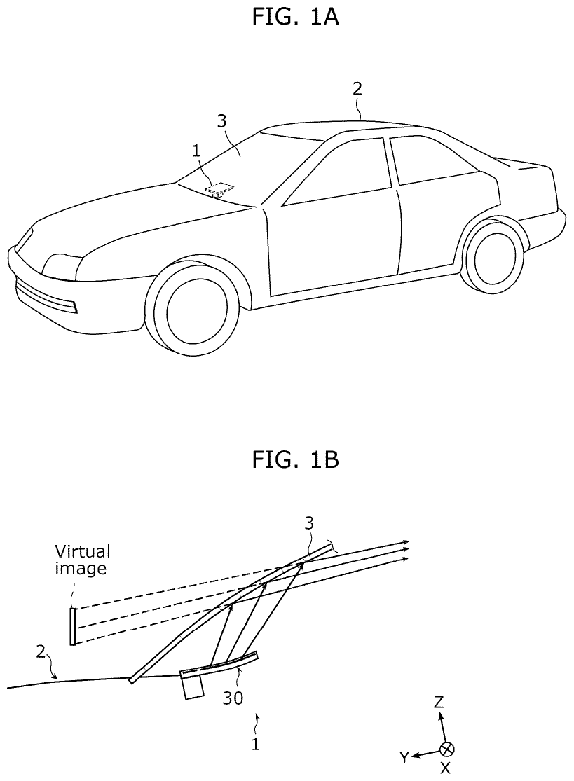

First, the configuration of display device 1 will be described with reference to FIG. 1A to FIG. 4.

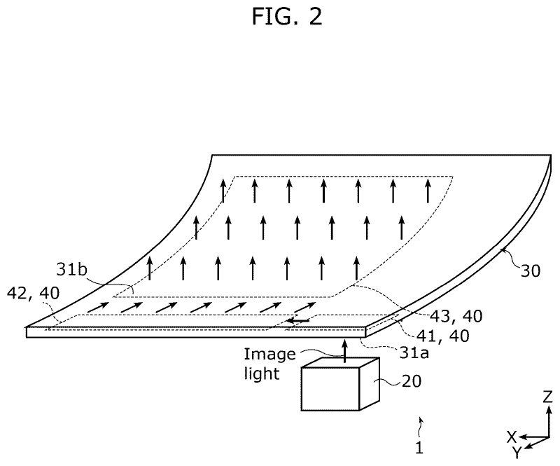

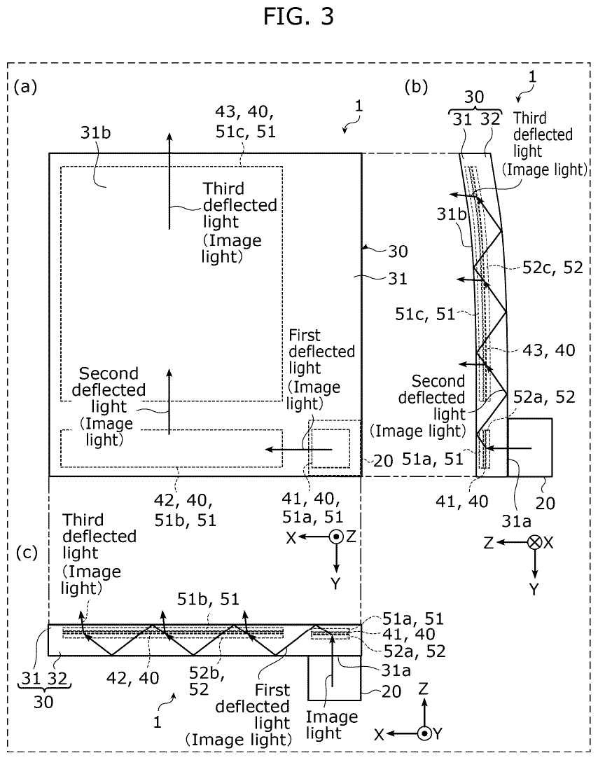

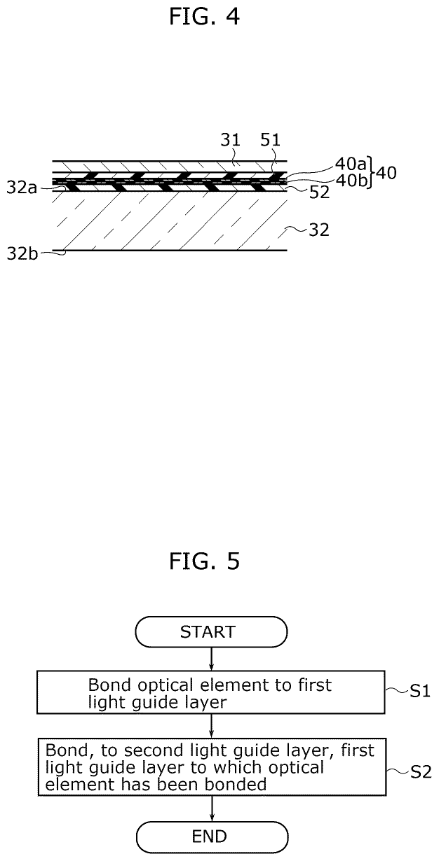

FIG. 1A is a schematic diagram illustrating an example of vehicle 2 in which display device 1 according to the present embodiment is disposed. FIG. 1B is a schematic diagram illustrating display device 1 according to the embodiment and vehicle 2 viewed along the rightward direction (positive X-axis direction). FIG. 2 is a perspective view of display device 1 according to the embodiment. FIG. 3 is a diagram illustrating display device 1. In FIG. 3, (a) is a top view of display device 1, (b) is a side view of display device 1, and (c) is a front view of display device 1. FIG. 4 is a cross-sectional view of light guide 30.

In FIG. 2, for example, the direction of arrangement of folding optical element 42 with respect to entrance optical element 41 is defined as the positive X-axis direction, the direction of arrangement of folding optical element 42 with respect to exit optical element 43 is defined as the positive Y-axis direction, and the direction of arrangement of entrance optical element 41 with respect to image light emitter 20 is defined as the positive Z-axis direction.

As illustrated in FIG. 1A and FIG. 1B, display device 1 is, for example, disposed in the dashboard (also called instrument panel) of vehicle 2, such as an automobile. Windshield (also called windscreen) 3 is disposed above the dashboard of vehicle 2. Light guide 30 of display device 1 is disposed between the dashboard and windshield 3. Light guide 30 can emit image light toward windshield 3. The specific configuration of light guide 30 will be described later.

Display device 1 is capable of causing image light that has exited light guide 30 to enter the eye of a user who is, for example, the driver or passenger, by causing the image light to be reflected by windshield 3. In other words, display device 1 projects the image indicated by the image light emitted from image light emitter 20 in front of windshield 3, so that a virtual image corresponding to the image is displayed on windshield 3. The image light is light that indicates an image, and displays a virtual image in front of windshield 3. The image is a still image or a moving image, and is an image indicating numbers, letters, graphics, or the like.

As illustrated in FIG. 1B and FIG. 2, display device 1 includes image light emitter 20 and light guide 30.

### Image Light Emitter 20

Image light emitter 20 is an image generating device that outputs image light to light guide 30. Image light emitter 20 is capable of projecting a predetermined image onto windshield 3 via light guide 30 by emitting image light that indicates an image with a rectangular outline. Image light emitter 20 is capable of emitting image light from a rectangular emitting surface. The image light emitted from image light emitter 20 is emitted to windshield 3 by entering light guide 30, passing through light guide 30, and then exiting light guide 30. With this, the image light is reflected by windshield 3, and an image is projected onto windshield 3, so that the user perceives a virtual image.

Image light emitter 20 includes a plurality of emitters, a plurality of dichroic mirrors, a condenser lens, a mirror, and an exit surface.

The plurality of emitters emit light beams that are in given wavelength bands that are different from one another. The plurality of dichroic mirrors are arranged on the light beams emitted by the emitters to reflect the light beam in a given wavelength band and transmit the light beams in other wavelength bands. The condenser lens is a lens that condenses the light beams emitted through the dichroic mirrors to the plurality of mirrors. The exit surface is a screen, such as a microlens array, or a liquid crystal display element such as a liquid crystal display (LCD). When light beams of different wavelength bands are emitted from the mirror side, the exit surface allows the transmitted light to exit as image light.

### Light Guide 30

As illustrated in FIG. 2 and FIG. 3, light guide 30 is a holographic light guide that displays, to the user, an image indicated by image light. Light guide 30 is light-transmissive and capable of enlarging, in the X-axis and Y-axis directions, the image indicated by the image light emitted from image light emitter 20 and outputting the image.

Light guide 30 is in a curved rectangular shape. Specifically, light guide 30 is rectangular in shape when viewed along the Z-axis direction, and is in a curved shape that is bent upward on the negative Y-axis side in the Y-axis direction. Being bent upward on the negative Y-axis side in the Y-axis direction means that light guide 30 is curved to project on the negative Z-axis side.

Inside vehicle 2, light guide 30 is positioned so as to be opposite to image light emitter 20 and opposite to windshield 3.

Entrance surface 31a and exit surface 31b are formed in light guide 30.

Entrance surface 31a is positioned so as to be opposite the exit surface of image light emitter 20. Entrance surface 31a is a surface from which the image light emitted from the exit surface of image light emitter 20 enters. Entrance surface 31a is a portion of the back surface of light guide 30 that is rectangular in shape. The back surface of light guide 30 is the surface on a reverse side of exit surface 31b.

Exit surface 31b is a surface from which the image light that has entered entrance surface 31a and propagated through light guide 30 exits toward windshield 3. Exit surface 31b is positioned opposite to windshield 3, and away from windshield 3 by a predetermined distance. Exit surface 31b is a portion of the front surface of light guide 30.

As illustrated in FIG. 3 and FIG. 4, light guide 30 includes first light guide layer 31, second light guide layer 32, optical element 40, first bonding component 51, and second bonding component 52.

First light guide layer 31 is disposed closer to windshield 3 than second light guide layer 32. In addition, second light guide layer 32 is disposed closer to image light emitter 20 than first light guide layer 31. Therefore, second light guide layer 32 has entrance surface 31a formed to be opposite to image light emitter 20. Entrance surface 31a is a surface opposite to image light emitter 20 and is a portion of the back surface of second light guide layer 32. Furthermore, first light guide layer 31 has exit surface 31b formed to be opposite to windshield 3. Exit surface 31b is a surface that is a portion of the front surface of first light guide layer 31.

Light guide 30 has a stack structure including optical element 40 disposed between first light guide layer 31 and second light guide layer 32. Specifically, optical element 40 is stacked on front surface 32a of second light guide layer 32 via second bonding component 52, and first light guide layer 31 is further stacked on optical element 40 via first bonding component 51. Front surface 32a of second light guide layer 32 is a surface on the reverse side of entrance surface 31a of second light guide layer 32 and is a surface on which second bonding component 52 is disposed.

First light guide layer 31 is in a form of a film. First light guide layer 31 is formed from a light-transmissive material, such as glass. First light guide layer 31 is bendable and stretchable at room temperature. Note that the material of first light guide layer 31 is not limited to glass. For example, the material of first light guide layer 31 may be a light-transmissive resin film.

Furthermore, second light guide layer 32 is in a form of a curved plate. Second light guide layer 32 is formed from a light-transmissive material, such as glass. Second light guide layer 32 stays in a curved shape at room temperature. Therefore, first light guide layer 31 is provided in a curved shape by being bonded along front surface 32a of second light guide layer 32. That is, first light guide layer 31 is disposed so as to conform to the shape of front surface 32a of second light guide layer 32.

As illustrated in FIG. 4, the thickness of first light guide layer 31 is greater than the thickness of first bonding component 51, the thickness of second bonding component 52, and the thickness of optical element 40. In addition, the thickness of first light guide layer 31 is less than the thickness of second light guide layer 32. The thickness of first light guide layer 31 is at most 1/5 the thickness of second light guide layer 32. That is, first light guide layer 31 has a thickness that allows first light guide layer 31 to be bendable and stretchable to such an extent that first light guide layer 31 can be disposed in conformity to the shape of front surface 32a of second light guide layer 32. The thickness of first light guide layer 31 is 0.2 mm, for example. Furthermore, the thickness of second light guide layer 32 is 2.8 mm, for example. The thickness of optical element 40 is 2 μm, for example. The thickness of first bonding component 51 and the thickness of second bonding component 52 are 0.1 mm, for example. The thickness of first light guide layer 31, the thickness of second light guide layer 32, the thickness of optical element 40, the thickness of first bonding component 51, and the thickness of second bonding component 52 are just examples, and the present disclosure is not limited to these.

Second light guide layer 32 has front surface 32a on the side of first light guide layer 31 and back surface 32b that is on the reverse side of front surface 32a. Front surface 32a of second light guide layer 32 is rougher than back surface 32b of second light guide layer 32. That is, front surface 32a of second light guide layer 32 has a higher surface roughness than back surface 32b of second light guide layer 32. When molding second light guide layer 32 in a curved shape using a mold, second light guide layer 32 may be molded in such a manner that a surface that will become front surface 32a of second light guide layer 32 is in contact with the mold. Front surface 32a of second light guide layer 32 is an example of a first face. Back surface 32b of second light guide layer 32 is an example of a second face.

As illustrated in FIGS. 2 and 3, optical element 40 is a light-transmissive hologram element that diffracts and emits light propagating in first light guide layer 31 and second light guide layer 32. Optical element 40 is disposed between first light guide layer 31 and second light guide layer 32 by being bonded to first light guide layer 31 by first bonding component 51 and bonded to second light guide layer 32 by second bonding component 52.

Furthermore, optical element 40 has light-transmissive optical layer 40a and light-transmissive protective layer 40b. Optical layer 40a is an optical element main body that diffracts light propagating in first light guide layer 31 and second light guide layer 32. Protective layer 40b is provided on the back surface of optical layer 40a, that is, the surface of optical layer 40a on the side of second light guide layer 32. Protective layer 40b contains a material having a water-proof effect, such as polyamide or cyclic olefin copolymer. Accordingly, protective layer 40b can protect optical layer 40a. Note that optical element 40 need not have protective layer 40b, and protective layer 40b is not an essential constituent element of optical element 40. Such optical element 40 includes entrance optical element 41, folding optical element 42, and exit optical element 43. Entrance optical element 41 and folding optical element 42 are arranged side by side along the X-axis. Folding optical element 42 and exit optical element 43 are arranged side by side along the Y-axis. When viewed along the Z-axis direction, entrance optical element 41 is arranged to overlap entrance surface 31a of light guide 30 and to overlap the exit surface of image light emitter 20 that is arranged on the negative Z-axis side of light guide 30.

Entrance optical element 41 is in the shape of a rectangular plate. Entrance optical element 41 may curve following light guide 30.

Entrance optical element 41 receives image light that is emitted from the exit surface of image light emitter 20 and travels in the positive Z-axis direction, and emits the image light so as to enter folding optical element 42. Specifically, entrance optical element 41 can emit first deflected light (image light) obtained by deflecting the image light from image light emitter 20 that has entered entrance surface 31a. More specifically, entrance optical element 41 deflects the image light that has entered light guide 30 and is propagating in light guide 30 through diffraction according to the diffraction efficiency of entrance optical element 41, and emits the image light as the first deflected light that propagates in the positive X-axis direction. The first deflected light deflected through diffraction by entrance optical element 41 enters folding optical element 42.

Folding optical element 42 is disposed on the positive X-axis side of entrance optical element 41, i.e., on the light exit side of entrance optical element 41, and on the positive Y-axis side of exit optical element 43, i.e., on the light entrance side of exit optical element 43.

Folding optical element 42 is in the shape of a rectangle elongated in the X-axis direction. Folding optical element 42 may be curved along light guide 30.

The first deflected light emitted by entrance optical element 41 enters folding optical element 42. Folding optical element 42 emits second deflected light (image light) obtained by further deflecting through diffraction the first deflected light, which has been deflected through diffraction by entrance optical element 41. Specifically, each time the first deflected light having passed through entrance optical element 41 enters (passes through) folding optical element 42, folding optical element 42 emits, toward exit optical element 43, second deflected light (image light) obtained by further deflecting the received first deflected light through diffraction. More specifically, folding optical element 42 further deflects the first deflected light that has entered folding optical element 42 and is propagating in light guide 30 in the positive X-axis direction, through diffraction according to the diffraction efficiency of folding optical element 42. In this process, folding optical element 42 serves to enlarge the image of the image light in the X-axis direction. Accordingly, folding optical element 42 emits, in the negative Y-axis direction, second deflected light enlarged in the X-axis direction. The second deflected light deflected through diffraction by folding optical element 42 enters exit optical element 43.

Exit optical element 43 is disposed on the negative Y-axis side of folding optical element 42, i.e., disposed to be opposite to the light entrance side of folding optical element 42. In addition, exit optical element 43 is disposed to overlap and be opposite to exit surface 31b of light guide 30. Exit optical element is rectangular in shape when viewed along the Z-axis direction, and is in a curved shape that is bent upward on the negative Y-axis side in the Y-axis direction. The second deflected light emitted by folding optical element 42 enters exit optical element 43. Exit optical element 43 further deflects through diffraction the second deflected light, which has been deflected through diffraction by folding optical element 42, and emits the resulting third deflected light (image light) to the outside of light guide 30. Specifically, each time the second deflected light having passed through folding optical element 42 enters (passes through) exit optical element 43, exit optical element 43 emits, at a predetermined exit angle, third deflected light (image light) obtained by further deflecting the received second deflected light through diffraction. More specifically, exit optical element 43 further deflects the second deflected light that has been deflected through diffraction by folding optical element 42 and is propagating in light guide 30 in the negative Y-axis direction, through diffraction according to the diffraction efficiency of exit optical element 43. In this process, exit optical element 43 serves to further enlarge the image of the second deflected light, which has been enlarged in the X-axis direction, in substantially the Y-axis direction. Accordingly, exit optical element 43 emits, to the outside of light guide 30 at a predetermined exit angle, the third deflected light that has been enlarged in the X-axis direction and substantially the Y-axis direction. That is, exit optical element 43 emits, at a predetermined exit angle, the third deflected light that is enlarged in the X-axis direction and the Y-axis direction by further enlarging, in substantially the Y-axis direction, the second deflected In the present light emitted by folding optical element 42. embodiment, exit optical element 43 emits the third deflected light toward windshield 3 in the positive Z-axis direction.

Here, the predetermined exit angle is an exit angle of the third deflected light emitted from the exit surface of exit optical element 43, and is an angle of the emitted light with respect to the normal to the exit surface of exit optical element 43.

Furthermore, exit optical element 43 may diverge the emitted image light so that the exit angle of the third deflected light varies. Exit optical element 43 may deflect the received image light through diffraction in such a manner that the exit angle varies with the position on (part of) exit optical element 43. Accordingly, exit optical element 43 can cause part of the image light deflected through diffraction by exit optical element 43 to have a different exit angle from other part of the image light.

As illustrated in FIGS. 3 and 4, first bonding component 51 is a light-transmissive adhesive. First bonding component 51 bonds first light guide layer 31 and optical element 40 to each other. Specifically, first bonding component 51 (51a, 51b, and 51c) is stacked on the back surface of first light guide layer 31 and bonds first light guide layer 31 and optical element 40 to each other. More specifically, first bonding component 51a bonds first light guide layer 31 and entrance optical element 41 to each other. Furthermore, first bonding component 51b bonds first light guide layer 31 and folding optical element 42 to each other. Furthermore, first bonding component 51c bonds first light guide layer 31 and exit optical element 43 to each other. The back surface of first light guide layer 31 is a surface of first light guide layer 31 on the reverse side of exit surface 31b and is a surface on which first bonding component 51 is disposed.

Second bonding component 52 is a light-transmissive adhesive. Second bonding component 52 bonds second light guide layer 32 and optical element 40 to each other. Specifically, second bonding component 52 (52a, 52b, and 52c) is stacked on front surface 32a of second light guide layer 32 and bonds second light guide layer 32 and optical element 40 to each other. More specifically, second bonding component 52a bonds second light guide layer 32 and entrance optical element 41 to each other. Furthermore, second bonding component 52b bonds second light guide layer 32 and folding optical element 42 to each other. Furthermore, second bonding component 52c bonds second light guide layer 32 and exit optical element 43 to each other.

### Propagation Path of Image Light

Next, a propagation path of the image light according to the present embodiment will be described. In such display device 1, image light emitted by image light emitter 20 enters entrance surface 31a of second light guide layer 32 in light guide 30. The image light having entered second light guide layer 32 passes through second light guide layer 32 and second bonding component 52a, and then enters entrance optical element 41.

The image light having entered entrance optical element 41 is deflected through diffraction and emitted as first deflected light from entrance optical element 41. The first deflected light emitted from entrance optical element 41 passes through first bonding component 51a, light guide 30, and second bonding component 52b, and then enters folding optical element 42.

The first deflected light having entered folding optical element 42 is further deflected through diffraction and emitted as second deflected light from folding optical element 42. The second deflected light emitted from folding optical element 42 passes through first bonding component 51b, light guide 30, and second bonding component 52c, and then enters exit optical element 43.

The second deflected light having entered exit optical element 43 is further deflected through diffraction and emitted as third deflected light from exit optical element 43. The third deflected light emitted from exit optical element 43 passes through first bonding component 51c and light guide 30, and is then emitted from exit surface 31b of light guide 30. The third deflected light emitted from exit surface 31b of light guide 30 is incident on windshield 3. Accordingly, the third deflected light, that is, the image light is reflected by windshield 3, and thus, the image is projected onto windshield 3. As a result, the user can perceive a virtual image projected onto windshield 3.

### Manufacturing Method

Next, a method for manufacturing light guide 30 according to the present embodiment will be described.

FIG. 5 is a flowchart illustrating a method for manufacturing light guide 30.

First light guide layer 31 that is in film form, second light guide 32 that is curved, optical element 40, first bonding component 51, and second bonding component 52 are provided in advance.

First, as illustrated in FIG. 5, a worker or a manufacturing device bonds optical element 40 which diffracts and emits light, to first light guide layer 31 (S1: First step). Specifically, in the first step, optical element 40 is bonded to first light guide layer 31 via first bonding component 51.

Next, a worker or a manufacturing device bonds first light guide layer 31 to which optical element 40 has been bonded, to top face 32a of second light guide layer 32 in such a way that optical element 40 is disposed between first light guide layer 31 and second light guide layer 32 (S2: Second step). Specifically, in the second step, first light guide layer 31 to which optical element 40 has been bonded is bonded to second light guide layer 32 via second bonding component 52. Optical element 40 and first light guide layer 31 that have a thin thickness need not be molded into a curve beforehand like the curved-shaped light guide layer 32. For this reason, first light guide layer 31 to which optical element 40 has been bonded can be stuck onto second light guide layer 32 via bonding component 52 by pressing first light guide layer 31 to which optical element 40 has been bonded, against second light guide layer 32 using a roller, or the like, for example.

Accordingly, light guide 30 in which second light guide layer 32, second bonding component 52, optical element 40, first bonding component 51, and first light guide layer 31 are stacked in the stated order is obtained.

### Advantageous Effects

Next, advantageous effects of display device 1 according to the present embodiment will be described.

The optical waveguide in PTL 1 is configured by placing the substrate, the hologram layer, and the cover layer on top of each other. When the curvature of the substrate and the curvature of the cover layer are different, it becomes difficult to bind the substrate and the cover layer together, and thus a constant bending precision in the substrate and cover layer is required. Furthermore, it is possible to ensure the bending precision of the optical waveguide by subjecting the substrate, the hologram layer, and the cover layer to pressing after they have been placed on top of each other. In this case, there is the problem of distortion occurring in light guides such as the substrate and cover layer.

In view of this, as described above, display device 1 according to the present embodiment includes light guide 30 that is curved and image light emitter 20 that outputs image light to light guide 30. Furthermore, light guide 30 includes first light guide layer 31, second light guide layer 32, and optical element 40 that is disposed between first light guide layer 31 and second light guide layer 32 and diffracts and emits light (image light) propagating through first light guide layer 31 and second light guide layer 32. In addition, the thickness of first light guide layer 31 is less than the thickness of second light guide layer 32.

Accordingly, first light guide layer 31 having a less thickness is disposed on second light guide layer 32 via optical element 40 in such a manner that first light guide layer 31 conforms to the surface shape of second light guide layer 32 that is curved. Therefore, compared with the case where a first light guide layer that is thick and curved and a second light guide layer that is thick and curved are placed on top of each other and then pressed, for example, distortion is less likely to occur in first light guide layer 31 and second light guide layer 32 of display device 1 according to the present embodiment.

Therefore, with display device 1 according to the embodiment, distortion occurring in light guide 30 can be suppressed. As a result, when the image light emitted from light guide 30 is incident on windshield 3, unevenness in the image indicated by the image light displayed on windshield 3 can be suppressed.

In particular, since first light guide layer 31 has a small thickness, first light guide layer 31 can be disposed along second light guide layer 32 that is curved. Accordingly, first light guide layer 31 and second light guide layer 32 need not be formed in such a manner that the curvature of first light guide layer 31 and the curvature of second light guide layer 32 agree with each other. Therefore, the increase of the manufacturing cost of display device 1 can be reduced.

Furthermore, display device 1 according to the present embodiment includes light guide 30 that is curved and image light emitter 20 that outputs image light to light guide 30. Furthermore, light guide 30 includes first light guide layer 31, second light guide layer 32, and optical element 40 that is disposed between first light guide layer 31 and second light guide layer 32 and diffracts and emits light propagating through first light guide layer 31 and second light guide layer 32. In addition, second light guide layer 32 stays in the curved shape at room temperature. In addition, first light guide layer 31 is bendable and stretchable at room temperature.

In this case, the same advantageous effects are achieved.

Furthermore, in display device 1 according to the present embodiment, first light guide layer 31 is in a form of a film. Furthermore, second light guide layer 32 is in a curved shape. First light guide layer 31 is provided in a curved shape by being bonded along front surface 32a of second light guide layer 32.

Accordingly, since first light guide layer 31 is flexible, first light guide layer 31 can be disposed on second light guide layer 32 so as to conform to the surface shape of second light guide layer 32 so that no distortion occurs in first light guide layer 31 and second light guide layer 32. Therefore, in display device 1 according to the present embodiment, distortion is less likely to occur in first light guide layer 31 and second light guide layer 32.

Furthermore, display device 1 according to the present embodiment further includes first bonding component 51 that bonds first light guide layer 31 and optical element 40 to each other and second bonding component 52 that bonds second light guide layer 32 and optical element 40 to each other.

Accordingly, first bonding component 51 can bind first light guide layer 31 to optical element 40, and second bonding component 52 can bind optical element 40 to second light guide layer 32 that is thick. Accordingly, first light guide layer 31 and optical element 40 can be disposed on second light guide layer 32 in such a manner that the curvature of first light guide layer 31 and the curvature of second light guide layer 32 agree with each other. Therefore, in display device 1 according to the present embodiment, distortion is less likely to occur in first light guide layer 31 and second light guide layer 32.

Furthermore, in display device 1 according to the present embodiment, second light guide layer 32 has front surface 32a (first face) on the side of first light guide layer 31 and back surface 32b (second face) on the reverse side of front surface 32a. Front surface 32a is rougher than back surface 32b.

Accordingly, light propagating through first light guide layer 31 and second light guide layer 32 can propagate in a desired direction, because total reflection of the light occurs on back surface 32b of second light guide layer 32. Therefore, the light can be emitted in a desired direction from exit surface 31b of light guide 30. As a result, when the image light emitted from light guide 30 is incident on windshield 3, unevenness in the image indicated by the image light displayed on windshield 3 can be suppressed.

Furthermore, in display device 1 according to the present embodiment, the thickness of first light guide layer 31 is at most 1/5 the thickness of second light guide layer 32.

Accordingly, first light guide layer 31 that has a smaller thickness can be disposed on second light guide layer 32 so as to conform to the surface shape of second light guide layer 32 so that no distortion occurs in first light guide layer 31 and second light guide layer 32. Therefore, in display device 1 according to the present embodiment, distortion is less likely to occur in first light guide layer 31 and second light guide layer 32.

Furthermore, in display device 1 according to the present embodiment, the thickness of first light guide layer 31 is greater than the thickness of first bonding component 51, the thickness of second bonding component 52, and the thickness of optical element 40.

Accordingly, first light guide layer 31, first bonding component 51, second bonding component 52, and optical element 40, which have smaller thicknesses, can be disposed so as to conform to the surface shape of second light guide layer 32 so that no distortion occurs in first light guide layer 31 and second light guide layer 32. Therefore, in display device 1 according to the present embodiment, distortion is less likely to occur in first light guide layer 31 and second light guide layer 32.

Furthermore, a manufacturing method for light guide 30 according to the present embodiment includes a first step of bonding optical element 40, which diffracts and emits light, to first light guide layer 31, and a second step of bonding first light guide layer 31 to which optical element 40 has been bonded to second light guide layer 32 in such a manner that optical element 40 is disposed between first light guide layer 31 and second light guide layer 32. Furthermore, second light guide layer 32 is curved. In addition, the thickness of first light guide layer 31 is less than the thickness of second light guide layer 32.

Accordingly, after first light guide layer 31 having a less thickness is bonded to optical element 40, the stack structure of first light guide layer 31 and optical element 40 can be disposed so as to conform to the surface shape of second light guide layer 32 that is thick and curved. Therefore, compared with the case where a light guide is manufactured by placing a first light guide layer that is thick and curved and a second light guide layer that is thick and curved on top of each other, for example, distortion is less likely to occur in first light guide layer 31 and second light guide layer 32 of display device 1 according to the present embodiment.

Therefore, according to the manufacturing method for light guide 30 according to the embodiment, distortion occurring in light guide 30 can be suppressed.

Furthermore, optical element 40 is bonded to first light guide layer 31 via first bonding component 51 in the first step in the manufacturing method for light guide 30 according to the present embodiment, and first light guide layer 31 to which optical element 40 has been bonded is bonded to second light guide layer 32 via second bonding component 52 in the second step.

Accordingly, after first light guide layer 31 is bound to optical element 40 by first bonding component 51, the stack structure of first light guide layer 31 and optical element 40 can be bound, by second bonding component 52, to second light guide layer 32 that is thick.

Accordingly, first light guide layer 31 and optical element 40 can be disposed on second light guide layer 32 in such a manner that the curvature of first light guide layer 31 and the curvature of second light guide layer 32 agree with each other. Therefore, in display device 1 according to the present embodiment, distortion is less likely to occur in first light guide layer 31 and second light guide layer 32.

### Other Variations

Although a display device and a manufacturing method for a light guide according to the present disclosure have been described above with reference to an embodiment, the present disclosure is not limited to the embodiment. Various variations of the embodiment that occur to those skilled in the art may be included in the scope of the present disclosure without departing from the spirit of the present disclosure.

In display device 1 and the manufacturing method for light guide 30 according to the present disclosure, first light guide layer 31 may be disposed on the negative Z-axis side of optical element 40, and second light guide layer 32 may be disposed on the positive Z-axis side of optical element 40. In that case, exit surface 31b is formed in a part of front surface 32a of second light guide layer 32, and entrance surface 31a is formed in a part of the back surface of first light guide layer 31. Furthermore, optical element 40 may be bound to the front surface of first light guide layer 31 via first bonding component 51, and first light guide layer 31 to which optical element 40 has been bound may be bound to back surface 32b of second light guide layer 32 via second bonding component 52. Back surface 32b of second light guide layer 32 is rougher than front surface 32a of second light guide layer 32. Furthermore, the thickness of first light guide layer 31 is less than the thickness of second light guide layer 32. Furthermore, the thickness of first light guide layer 31 is greater than the thickness of first bonding component 51, the thickness of second bonding component 52, and the thickness of optical element 40. Furthermore, the thickness of first light guide layer 31 is at most 1/5 the thickness of second light guide layer 32. Front surface 32a of second light guide layer 32 is an example of the second face. Back surface 32b of second light guide layer 32 is an example of the first face.

In display device 1 and the manufacturing method for light guide 30 according to the present disclosure, a case has been illustrated where first bonding component 51, optical element 40, and second bonding component 52 are enclosed in first light guide layer 31 and second light guide layer 32. However, this is not intended to be limiting. First bonding component 51, optical element 40, and second bonding component 52 may be disposed to extend to the edge of the back surface of first light guide layer 31 and front surface 32a of second light guide layer 32.

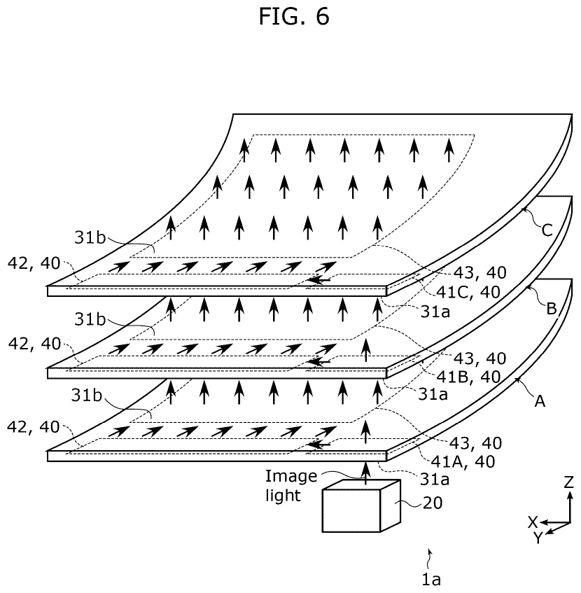

Furthermore, in display device 1a according to the present disclosure, one light guide 30 is illustrated. However, as illustrated in FIG. 6, display device 1a according to the present disclosure may include three light guides 30 (light guide A, light guide B, and light guide C). Light guide A, light guide B, and light guide C have the same configuration except that entrance optical element 41A of light guide A, entrance optical element 41B of light guide B, and entrance optical element 41C of light guide C are different in wavelength component to be selected. FIG. 6 is a perspective view of display device 1a according to a variation. In the case in FIG. 6, entrance surface 31a of light guide A may be disposed to be opposite to image light emitter 20. Light guide B may be disposed on the positive Z-axis side of light guide A so as to be opposite to light guide A at a predetermined distance from light guide A. Light guide C may be disposed on the positive Z-axis side of light guide B so as to be opposite to light guide B at a predetermined distance from light guide B. That is, light guide A, light guide B, and light guide C may be disposed at predetermined distances in this order of arrangement in the positive Z-axis direction so that an air layer is formed between light guide A and light guide B and between light guide B and light guide C. Entrance optical elements 41A, 41B, and 41C of light guides A, B, and C may be wavelength-selective dichroic mirrors. Light guide A may emit, to light guide B, third deflected light of a first wavelength component that corresponds to blue among the wavelength components included in the incident image light. Furthermore, entrance optical element 41A of light guide A may emit image light other than the first wavelength component to light guide B. The image light other than the first wavelength component is incident on light guide B, and light guide B may emit, to light guide C, third deflected light of a second wavelength component that corresponds to green among the wavelength components included in the incident image light other than the first wavelength component. Furthermore, entrance optical element 41B of light guide B may emit image light other than the first and second wavelength components to light guide C. Furthermore, light guide B may pass the third deflected light of the first wavelength component emitted by light guide A therethrough and emits the third deflected light of the first wavelength component to light guide C. The image light other than the first and second wavelength components is incident on light guide C, and light guide C may emit, to windshield 3, third deflected light of a third wavelength component that corresponds to red among the wavelength components included in the incident image light other than the first and second wavelength components. Furthermore, light guide C may pass the third deflected light of the first wavelength component emitted by light guide A and the third deflected light of the second wavelength component emitted by light guide B therethrough and emits the third deflected light of the first wavelength component and the third deflected light of the second wavelength component to windshield 3.

It should be noted that forms obtained through various modifications to the above embodiments conceived by those skilled in the art, as well as forms realized by arbitrarily combining elements and functions in the embodiments, without departing from the essence of the present disclosure are also included in the present disclosure.

### Supplementary Notes

The features of the display device and the light guide manufacturing method described based on the above embodiments will be described below.

### Technique 1

A display device including:

a light guide that is curved; and

an image light emitter that outputs image light to the light guide,

wherein

the light guide includes:
a first light guide layer;
a second light guide layer; and
an optical element that is disposed between the first light guide layer and the second light guide layer, the optical element diffracting and emitting light propagating in the first light guide layer and the second light guide layer, and

the first light guide layer has a thickness less than a thickness of the second light guide layer.

### Technique 2

The display device according to Technique 1, wherein the first light guide layer is in a form of a film, the second light guide layer is curved; the first light guide layer is provided in a curved shape by being bonded along the second light guide layer.

### Technique 3

A display device including:

a light guide that is curved; and

an image light emitter that outputs image light to the light guide, wherein

the light guide includes:
a first light guide layer;
a second light guide layer; and
an optical element that is disposed between the first light guide layer and the second light guide layer, the optical element diffracting and emitting light propagating in the first light guide layer and the second light guide layer,

the second light guide layer stays in a curved shape at room temperature, and

the first light guide layer is bendable and stretchable at room temperature.

### Technique 4

The display device according to any one of Techniques 1 to 3, further including:

a first bonding component that bonds the first light guide layer and the second light guide layer; and

a second bonding component that bonds the second light guide layer and the optical element.

### Technique 5

The display device according to any one of Techniques 1 to 4, wherein

the second light guide layer includes:
a first face that is closer to the first light guide layer; and
a second face that is on a reverse side of the first face, and

the first face is rougher than the second face.

### Technique 6

The display device according to any one of Techniques 1 to 5, wherein

the first light guide layer has a thickness that is at most ⅕ a thickness of the second light guide layer.

### Technique 7

The display device according to Technique 4, wherein

wherein a thickness of the first light guide layer is greater than: a thickness of the first bonding component; a thickness of the second bonding element; and a thickness of the optical element.

### Technique 8

A method for manufacturing a light guide, the method including:

bonding an optical element to a first light guide layer, the optical element diffracting and emitting light;

bonding the first light guide layer to which the optical layer has been bonded, to a second light guide layer so that the optical element is disposed between the first light guide layer and the second light guide layer; wherein

the second light guide layer is curved, and

the first light guide layer has a thickness less than a thickness of the second light guide layer.

### Technique 9

The method of manufacturing the light guide according to Technique 8, wherein

in the bonding of the optical element, the optical element is bonded to the first light guide layer via a first bonding component, and

in the bonding of the first light guide layer, the first light guide layer to which the optical layer has been bonded is bonded to the second light guide layer via a second bonding component.

Further Information about Technical Background to this Application

The disclosures of the following patent applications including specification, drawings, and claims are incorporated herein by reference in their entirety: Japanese Patent Application No. 2022-211144 filed on Dec. 28, 2022, and PCT International Patent Application No. PCT/JP2023/045346 filed on Dec. 18, 2023.

### Industrial Applicability

The present disclosure is usable in a head-up display device, or the like, of a vehicle.

1. A display device comprising:
a light guide that is curved; and
an image light emitter that outputs image light to the light guide,
wherein
the light guide includes:
a first light guide layer;
a second light guide layer; and
an optical element that is disposed between the first light guide layer and the second light guide layer, the optical element diffracting and emitting light propagating in the first light guide layer and the second light guide layer, and
the first light guide layer has a thickness less than a thickness of the second light guide layer.

2. The display device according to claim 1, wherein
the first light guide layer is in a form of a film,
the second light guide layer is curved;
the first light guide layer is provided in a curved shape by being bonded along the second light guide layer.

3. A display device comprising:
a light guide that is curved; and
an image light emitter that outputs image light to the light guide, wherein
the light guide includes:
a first light guide layer;
a second light guide layer; and
an optical element that is disposed between the first light guide layer and the second light guide layer, the optical element diffracting and emitting light propagating in the first light guide layer and the second light guide layer,
the second light guide layer stays in a curved shape at room temperature, and
the first light guide layer is bendable and stretchable at room temperature.

4. The display device according to claim 1, further comprising:
a first bonding component that bonds the first light guide layer and the second light guide layer; and
a second bonding component that bonds the second light guide layer and the optical element.

5. The display device according to claim 1, wherein
the second light guide layer includes:
a first face that is closer to the first light guide layer; and
a second face that is on a reverse side of the first face, and
the first face is rougher than the second face.

6. The display device according to claim 1, wherein
the first light guide layer has a thickness that is at most ⅕ a thickness of the second light guide layer.

7. The display device according to claim 4, wherein
wherein a thickness of the first light guide layer is greater than: a thickness of the first bonding component; a thickness of the second bonding element; and a thickness of the optical element.

8. A method for manufacturing a light guide, the method comprising:
bonding an optical element to a first light guide layer, the optical element diffracting and emitting light;
bonding the first light guide layer to which the optical layer has been bonded, to a second light guide layer so that the optical element is disposed between the first light guide layer and the second light guide layer; wherein
the second light guide layer is curved, and
the first light guide layer has a thickness less than a thickness of the second light guide layer.

9. The method of manufacturing the light guide according to claim 8, wherein
in the bonding of the optical element, the optical element is bonded to the first light guide layer via a first bonding component, and
in the bonding of the first light guide layer, the first light guide layer to which the optical layer has been bonded is bonded to the second light guide layer via a second bonding component.
